(19) United States
(12) Patent Application Publication
(10) Pub. No.: US 2013/0293986 A1
(43) Pub. Date: Nov. 7, 2013

(54) Current Limit Circuit Architecture For Low Drop-Out Voltage Regulators

(71) Applicants: Valentin Lerner, Tikva (IL); Dan Pollak, Kadima (IL)

(72) Inventors: Valentin Lerner, Tikva (IL); Dan Pollak, Kadima (IL)

(73) Assignee: Tower Semiconductor Ltd., Migdal Haemek (IL)

(21) Appl. No.: 13/465,877

(22) Filed: May 7, 2012

(51) Int. Cl. H02H 9/02

(52) U.S. Cl. 361/18

(57) ABSTRACT

A current limiting circuit for a linear regulator includes an output stage transistor and a replica transistor, which have gates coupled to receive an output voltage from a linear amplifier and sources coupled to load circuitry. A drain of the output stage transistor is coupled to a V_{DD} supply terminal, while a drain of the replica transistor is coupled to the V_{DD} supply terminal through a first resistor. The output stage transistor and replica transistor are operated in saturation, such that proportional currents flow through these transistors. The voltage drop across the first resistor provides a first voltage, which is applied to a second amplifier. A reference voltage is also applied to the second amplifier. When the first voltage becomes less than the reference voltage, a feedback transistor is enabled to pull down the output voltage of the linear amplifier, thereby limiting the output current supplied to the load circuitry.

### FIELD OF THE INVENTION

The present invention relates to a current limiting circuit for use in connection with low drop out voltage regulators.

### RELATED ART

U.S. Pat. No. 7,986,499 to Wang et al. describes a conventional current limiting circuit for limiting a current passing through an output pass circuit of a voltage regulator. The current limiting circuit includes a current sampling circuit for sampling the current passing through the output pass circuit to obtain a duplicated current that is proportional to the current passing through the output pass circuit. As used herein, a current sampling circuit is a circuit that copies the gate, source and drain voltages of an output stage transistor (e.g., MPass of FIG. 4) to a scaled transistor (e.g., MP1 of FIG. 4). Note that the source voltages of transistors MPass and MP1 are equalized through the transistors MP3, MP2, MN1 and MN2 of Wang et al.

The current limiting circuit of Wang et al. also includes a current mirror circuit for producing a mirror current that is proportional to the duplicated current, a current to voltage converter for producing a voltage proportional to the mirror current, and a voltage comparator that compares the voltage produced by the current to voltage converter with a threshold voltage, and turns off the output pass circuit when the voltage produced by the current to voltage converter is larger than or equal to the threshold voltage. In this manner, the conventional current limiting circuit limits a current passing through the output pass circuit of the voltage regulator.

Using current sampling circuitry to measure current through the output pass circuit of the voltage regulator undesirably complicates the process of achieving overall circuit stability. Moreover, the current limiting technique is limited by the headroom required to operate the current sampling circuitry, and therefore does not guarantee correct current limiting behavior for the entire range of possible output voltages, particularly output voltages close to 0 Volts. More specifically, the current sampling circuit described by Wang et al. requires headroom of at least 1 PMOS transistor threshold voltage V_{THP} (associated with transistor MP3), and a saturation voltage V_{DSAT} (associated with transistor MN2). As a result, the minimum output voltage of the current sampling circuit of Wang et al. is equal to V_{THP}+V_{DSAT}. Below this voltage, the current sampling circuit will not operate.

It would therefore be desirable to have a method and circuit for performing a current limiting operation without requiring the current sampling circuitry described by of Wang et al.

It would further be desirable for this method and circuit to ensure that proper current limiting operation is implemented for all possible output voltages, particularly output voltages close to 0 Volts.

### SUMMARY

Accordingly, the present invention provides a current limiting circuit that provides protection for high power applications designed to protect an associated regulator and load from external shorts and excessive current consumption by the load circuitry. The current limiting circuit of the present invention limits the load current, when the load current exceeds a predetermined threshold current, by lowering the output voltage, thereby protecting output stage devices from undesirably high currents.

In accordance with one embodiment, the current limiting circuit of the present invention includes an output stage transistor and a replica transistor, which is scaled with respect to the output stage transistor. The gates of the output stage transistor and the replica transistor are commonly coupled to receive the output voltage from a linear amplifier. The sources of the output stage transistor and the replica transistor are commonly coupled to supply current to load circuitry. The drain of the output stage transistor is coupled to a V_{DD} supply terminal, while the drain of the replica transistor is coupled to the V_{DD} supply terminal through a first resistor. The output stage transistor and replica transistor are operated in saturation, such that proportional currents flow through these transistors (regardless of the different drain to source voltages across these transistors). The voltage drop across the first resistor provides a first voltage, which is applied to a first input terminal of a second amplifier. A second voltage is applied to a second input terminal of the second amplifier. The second voltage is derived, for example, by routing a predetermined threshold current through a second resistor coupled to the V_{DD} supply terminal. When the first voltage becomes less than the second voltage, a feedback transistor is enabled, thereby pulling down the output voltage of the linear amplifier, and limiting the output current supplied to the load circuitry through the output stage transistor and the replica transistor. The current limiting circuit of the present invention can be implemented with MOS, LDMOS or bipolar transistors in various embodiments.

The current limiting circuit of the present invention significantly simplifies the design phase of a product that implements this current limiting circuit, when compared with the common practices that incorporate the current sensing circuitry of a regulator.

The present invention will be more fully understood in view of the following description and drawings.

### BRIEF DESCRIPTION OF THE DRAWINGS

FIG. 1 is a circuit diagram of a current limiting circuit for use with a voltage regulator in accordance with one embodiment of the present invention.

FIG. 2 is a waveform diagram illustrating the output voltage and current behavior for the current limiting circuit of FIG. 1 in accordance with one embodiment of the present invention.

FIG. 3 is a circuit diagram illustrating a current limiting circuit that replaces MOS transistors of the current limiting circuit of FIG. 1 with bipolar transistors, in accordance with an alternate embodiment of the present invention.

### DETAILED DESCRIPTION

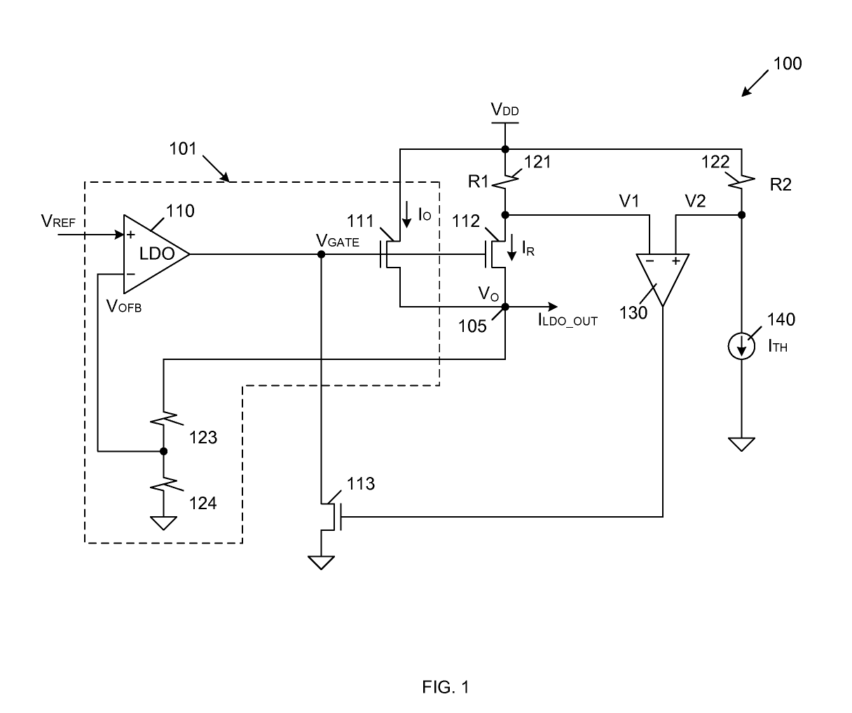

FIG. 1 is a circuit diagram of a current limiting circuit 100 for use with a low dropout (LDO) voltage regulator 101. Voltage regulator 101 includes linear amplifier 110, output stage transistor 111 and resistors 123-124 in accordance for one embodiment of the present invention. Current limiting circuit 100 includes n-channel MOS transistors 112-113, resistors 121-122, amplifier 130 and constant current source 140. As described in more detail below, current limiting circuit 100 provides an output voltage V_{O} on output terminal 105.

Linear amplifier 110 includes a non-inverting input coupled to receive a reference voltage V_{REF}, and an inverting input coupled to receive an output feedback voltage V_{OFB}. In accordance with one embodiment, the output feedback voltage V_{OFB} is derived from a resistive divider circuit that includes resistors 123-124, which are connected between the output terminal 105 and the ground supply terminal as illustrated. In the illustrated embodiment, resistors 123 and 124 have resistances of R3 and R4, respectively. During normal operating conditions (which are defined in more detail below), the output voltage V_{O} is maintained at a predetermined voltage of V_{REF}×R3/(R3+R4).

Low dropout voltage regulator 101 is a linear regulator that provides an output voltage (V_{GATE}), which is applied to the gates of NMOS transistors 111 and 112, and the drain of NMOS transistor 113. The sources of NMOS transistors 111 and 112 are commonly coupled to the output terminal 105, which provides the output current I_{LDO}_{_{—}}_{OUT} and the output voltage V_{O} to the associated load (not shown). The drain of NMOS transistor 111 is coupled to the V_{DD} voltage supply terminal. In accordance with one embodiment, the V_{DD} voltage supply terminal provides a V_{DD} supply voltage of about 5 to 20 Volts, depending upon the particular application. The drain of NMOS transistor 112 is coupled to the V_{DD} voltage supply terminal through resistor 121, which has a resistance R1. The drain of NMOS transistor 112 is also coupled to the inverting input of amplifier 130, whereby the voltage V1 is applied to this inverting input. Resistor 122, which has a resistance R2, is coupled between the V_{DD} voltage supply terminal and the non-inverting input of amplifier 130. Constant current source 140 is coupled between the non inverting input of amplifier 130 and the ground supply terminal. Constant current source 140 draws a constant threshold current I_{TH}, which is selected to determine a maximum current allowed through NMOS transistor 111, in a manner described in more detail below. The output of amplifier 130 is coupled to the gate of NMOS transistor 113. The source of NMOS transistor 113 is coupled to the ground supply terminal.

Current limiting circuit 100 is a protection circuit for high power applications, and is designed to protect regulator 101 from external shorts, as well as from excessive current consumption by the load circuitry. Current limiting circuit 100 limits the load current I_{LDO}_{_{—}}_{OUT} by lowering the voltage V_{O} on output node 105 when the current through NMOS transistor 111 reaches a predetermined maximum current. As a result, NMOS transistor 111 is protected from undesirably high currents. The architecture of current limiting circuit 100 significantly simplifies the design phase of the associated product (relative to common practices, which incorporate current sensing circuitry in the regulator).

NMOS transistor 111 may be referred to as an ‘output stage’ transistor, because this transistor 111 carries almost all of the load current I_{LDO}_{_{—}}_{OUT}. NMOS transistor 112 may be referred to as a ‘replica’ transistor, as the current through the output stage transistor 111 is replicated (with scaling) to this transistor 112.

The replica transistor 112 is scaled 1:N with respect to the output stage transistor 111, wherein N is, for example, between 10³ and 10⁷. As described above, NMOS transistors 111 and 112 share the same source and gate connections, thus preserving the same current density through both of these transistors 111 and 112 when operated in the saturation region. A main consideration for the architecture of current limiting circuit 100 is the requirement that both the output stage transistor 111 and the replica transistor 112 are kept in saturation, such that drain-to-source voltage (V_{DS}) differences between the output stage transistor 111 and the replica transistor 112 will have no effect on the currents flowing through these transistors 111 and 112. Thus, if the current through output stage transistor 111 is designated as I_{O}, and the current through replica transistor 112 is designated as I_{R}, then the following relationship is true within current limiting circuit 100.

I_{O}=I_{R}×N Equation (1)

As a result, the voltage drop across resistor 121 is proportional to the current through output stage transistor 111. More specifically, the voltage drop across resistor 121 (i.e., V_{R1}) can be defined as follows.

V_{R1}=I_{R}×R1=(I_{O}×R1)/N Equation (2)

Consequently, the voltage V1 applied to the inverting input of amplifier 130 can be defined as follows.

V1=V_{DD}−(I_{O}×R1)/N Equation (3)

The voltage V2 applied to the non-inverting input of amplifier 130 can be defined as follows.

V2=V_{DD}(I_{TH}×R2) Equation (4)

In accordance with one embodiment of the present invention, the resistances R1 and R2 are scaled such that R2/R1=M, wherein the manner of selecting M will become apparent in view of the following disclosure.

In accordance with one embodiment, the maximum allowable current through output stage transistor 111 is designated I_{MAX}. That is, the current limiting circuit 100 will limit the current I_{O} flowing through output stage transistor 111 to a maximum value of I_{MAX}. In order to limit the output stage current I_{O} in this manner, the threshold current I_{TH} drawn by constant current source 140 is selected in accordance with the following equation.

I_{TH}=I_{MAX}/(N×M) Equation (5)

By selecting the threshold current I_{TH} in this manner, the voltage V2 will be can be written as follows, in accordance with Equation (4).

V2=V_{DD}−(I_{MAX}×R2)/(N×M) Equation (6)

Because M is equal to R2/R1, Equation (6) can be simplified as follows.

V2=V_{DD}−(I_{MAX}×R1)/N Equation (7)

A comparison of Equations (3) and (7) indicates that, as long as the output stage current I_{O} is less than the maximum allowed current I_{MAX}, the voltage V1 will be greater than the voltage V2. Under these conditions, the output of amplifier 130 will trend towards its lowest voltage (i.e. 0 Volts), such that transistor 113 is turned off (non-conductive). As a result, transistor 113 does not affect the gate voltage V_{GATE} provided by LDO voltage regulator 101 (i.e., the current limiting circuit 100 is effectively disabled). Under these conditions, the LDO voltage regulator 101 alone controls the output current I_{LDO}_{_{—}}_{OUT} supplied by output stage transistor 111 and replica transistor 112. That is, the current limiting circuit 100 does not interfere with the normal operation of LDO regulator 101. This mode of operation is hereinafter referred to as the normal operating mode.

If the output stage current I_{O} exceeds the predetermined maximum current I_{MAX}, then the voltage V1 will become less than the voltage V2. Under these conditions, the output of amplifier 130 will increase above the ground supply voltage, thereby increasing the conductivity of transistor 113. In general, amplifier 130 amplifies the difference (error signal) between the voltages V1 and V2. Under these conditions, the gate voltage V_{GATE} is pulled downward (toward the ground supply voltage). Note that the voltage V_{O} on output node 105 is reduced in response to the gate voltage V_{GATE} being reduced, because the voltage V_{O} on output node 105 is equal to V_{GATE} minus the threshold voltage of output stage transistor 111. As the gate voltage V_{GATE} and the output voltage V_{O} are reduced, the conductivities of output stage transistor 111 and replica transistor 112 are reduced, such that the output stage current I_{O} and the replica (or sensing) current I_{R} are reduced. Reducing the replica current I_{R} causes the voltage V1 to increase, which creates a negative feedback loop. Equilibrium is reached when the voltage V1 becomes equal to the voltage V2. At this time, the output stage current I_{O} is equal to the predetermined maximum allowable current I_{MAX} (see, Equations (3) and (7)). This mode of operation is hereinafter referred to as the current limiting mode. While in the current limiting mode, the voltage V_{O} on output node 105 is controlled to ensure that the voltage V1 is equal to the voltage V2 in the manner described above.

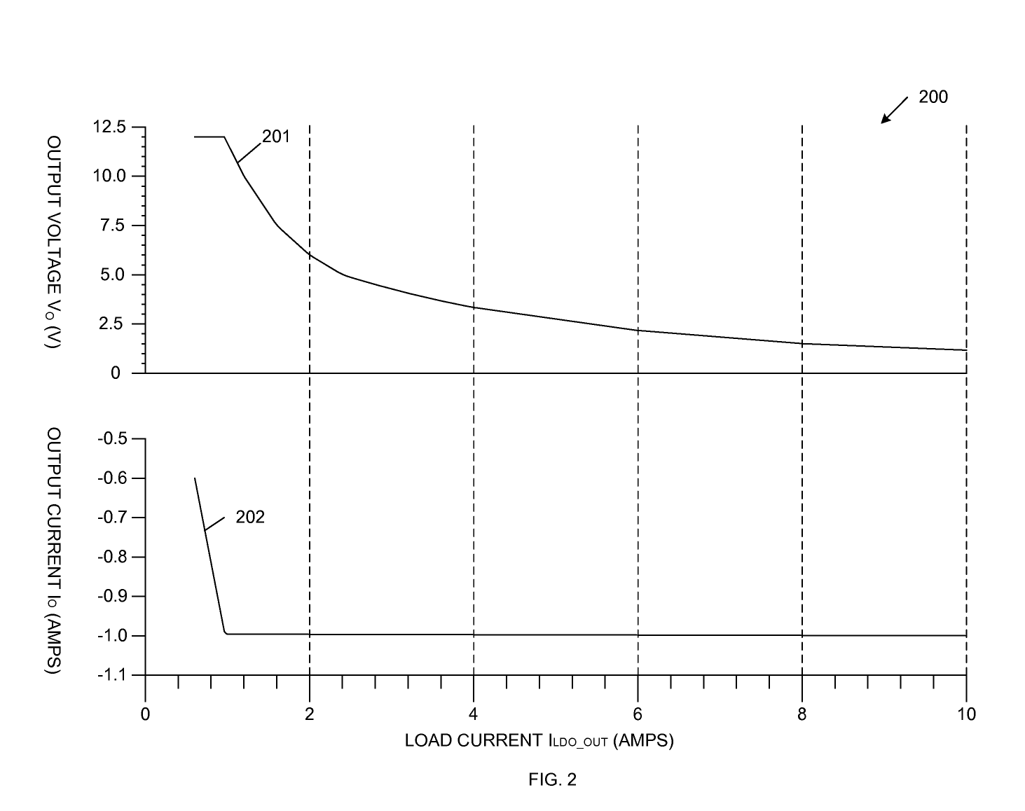

FIG. 2 is a waveform diagram 200 illustrating the output voltage and current behavior for current limiting circuit 100 in accordance with one embodiment of the present invention. As illustrated by FIG. 2, normal operating mode is implemented when the load current I_{LDO}_{_{—}}_{OUT} is about 0.6 Amps, the output current I_{O} is about −0.6 Amps, and the output voltage V_{O} is about 11.95 Volts. Note that the negative output current I_{O} indicates that current is being supplied by output stage transistor 111 to the load. As the load current I_{LDO}_{_{—}}_{OUT} increases (e.g., due to an external short or excessive current consumption by the load circuitry), the output current I_{O} supplied to the load also increases. As illustrated by curve 202, as the load current I_{LDO}_{_{—}}_{OUT} increases to 1.0 Amp, the output current I_{O} similarly increases to about −1.0 Amp. As illustrated by curve 201, the output voltage V_{O} remains at about 11.95 Volts during this time. The normal operating mode is still implemented at this point.

However, as the load current I_{LDO}_{_{—}}_{OUT} exceeds 1.0 Amps, the current limiting circuit 100 enters the current limiting mode described above, whereby the output voltage V_{O} is reduced, thereby maintaining the output current I_{O} at about −1.0 Amps.

Current limiting circuit 100 advantageously has no limitations on voltage limiting because the compared voltages V1 and V2 are referenced to the supply voltage V_{DD}, rather than to ground. Thus, current limiting circuit 100 operates correctly even for voltages that are close to ground on output node 105, which is the case for an external short on output node 105.

Moreover, the architecture of the current limiting circuit 100 of the present invention advantageously does not use a current sampling circuit (unlike the conventional current limiting circuit described by Wang et al.) thereby simplifying the design phase of any product that implements the current limiting circuit 100 of the present invention. Furthermore, because the current limiting circuit 100 does not use the current sensing circuitry of the LDO regulator 101, it is relatively easy to stabilize current limiting circuit 100 (because current limiting circuit 100 does not require stabilizing the current sensing circuitry of LDO regulator 101 in combination with the output circuitry), further simplifying the design phase of any product that implements current limiting circuit 100. Another advantage of current limiting circuit 100 is that power dissipation is reduced, because the current I_{R} flowing through the replica transistor 112 sensing circuitry is supplied to the load.

Although current sensing circuit 100 has been described in connection with an NMOS output stage transistor 111, an NMOS replica transistor 112 and an NMOS pull-down transistor 113, it is understood that in other embodiments, these transistors 111-113 may be replaced with other types of transistors, such as bipolar transistors or lateral diffused MOS (LDMOS) transistors. Thus, the MOS transistors 111-113 illustrated by FIG. 1 may represent LDMOS transistors.

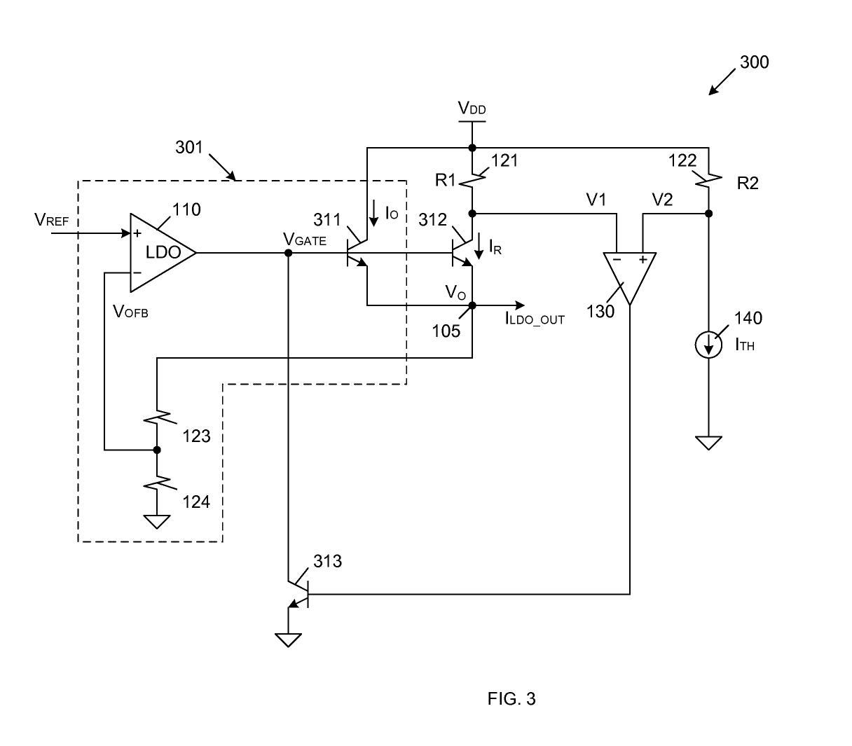

FIG. 3 is a circuit diagram illustrating a current limiting circuit 300 for use with a low dropout (LDO) voltage regulator 301. Note that LDO voltage regulator 301 replaces the NMOS transistor 111 of regulator 101 with an NPN bipolar transistor 311 having a base coupled to receive the V_{GATE} voltage provided by the output of linear amplifier 110, an emitter coupled to output terminal 105, and a collector coupled to the V_{DD} supply terminal. In addition, the NMOS transistors 112-113 of current limiting circuit 100 are replaced with NPN bipolar transistors 312-313, respectively, in current limiting circuit 300. The base of bipolar transistor 312 is coupled to receive the VGATE voltage, the emitter of bipolar transistor 312 is coupled to output terminal 105, and the collector of bipolar transistor is coupled to resistor 121 (and the inverting input of amplifier 130). Bipolar transistor 311 performs the output stage functions described above in connection with NMOS output stage transistor 111, while bipolar transistor 312 performs the sensing functions described above in connection with NMOS replica transistor 112. Bipolar transistors 311-312 are sized to exhibit the ratio N in the manner described above. Bipolar transistor 313, which includes a base coupled to the output terminal of amplifier 130, an emitter coupled to ground, and a collector coupled to the bases of bipolar transistors 311-312, implements the voltage pull down functions described above in connection with NMOS transistor 113. Although transistor 313 is a bipolar transistor in FIG. 3, it is understood that this transistor 313 can be any n-type transistor device (e.g., NMOS, bipolar or NLDMOS) in other embodiments.

Although the invention has been described in connection with several embodiments, it is understood that this invention is not limited to the embodiments disclosed, but is capable of various modifications, which would be apparent to a person skilled in the art. Thus, the invention is limited only by the following claims.

We claim:

1. A circuit comprising:
a first amplifier having an output terminal;
a first transistor that provides an output current to a load in response to a voltage on the output terminal, wherein a predefined voltage is provided to the load as long as the output current is less than a predefined maximum current;
a second transistor having a source connected to a source of the first transistor and a gate connected to a gate of the first transistor, the second transistor drawing a sensing current proportional to the output current; and
a resistor connected in series with a drain of the second transistor.

2. The circuit of claim 1, further comprising a first voltage supply terminal that receives a first supply voltage, wherein the resistor and a drain of the first transistor are coupled to the first voltage supply terminal.

3. The circuit of claim 1, wherein the sensing current is supplied to the load.

4. The circuit of claim 1, further comprising a second amplifier having a first input terminal coupled to the drain of the second transistor and a second input terminal coupled to receive a reference voltage.

5. The circuit of claim 2, further comprising:
a second resistor having a first terminal coupled to the first voltage supply terminal; and
a constant current source coupled between a second terminal of the second resistor and a ground supply terminal; and
a second amplifier having a first input terminal coupled to the drain of the second transistor and a second input terminal coupled to the second terminal of the second resistor.

6. The circuit of claim 5, further comprising a third transistor coupled between a gate of the first transistor and the ground supply terminal, the third transistor having a gate coupled to an output of the second amplifier.

7. The circuit of claim 1, wherein the first transistor and the second transistor are NMOS transistors.

8. The circuit of claim 1, wherein the first and second transistors are LDMOS transistors.

9. A method of limiting an output current generated in response to an output voltage of a linear amplifier, the method comprising:
commonly biasing gates of a first transistor and a second transistor with the output voltage of the linear amplifier, wherein the first and second transistors operate in saturation;
supplying an output current to a load through commonly coupled sources of the first and second transistors;
deriving a first voltage from a current through the second transistor;
comparing the first voltage with a reference voltage to obtain a comparison result; and
controlling the output voltage of the linear amplifier in response to the comparison result.

10. The method of claim 9, wherein the first voltage is derived from a voltage drop across a first resistor coupled in series with the second transistor.

11. The method of claim 10, further comprising generating the reference voltage by routing a constant current through a second resistor.

12. The method of claim 9, wherein the step of controlling the output voltage comprises pulling the output voltage down through a third transistor, wherein the third transistor is controlled by the comparison result.

13. A circuit comprising:
a first transistor that provides an output current to a load coupled to a source of the first transistor;
means for maintaining a predefined voltage at the source of the first transistor as long as the output current is less than a predetermined maximum current; and
means for reducing the voltage at the source of the first transistor below the predefined voltage if the output current reaches the predetermined maximum current, wherein the voltage at the source of the first transistor is reduced such that the output current is equal to the predetermined maximum current.

14. The circuit of claim 13, further comprising a first voltage supply terminal that receives a first supply voltage, wherein the first transistor includes a drain coupled to receive the first supply voltage from the first voltage supply terminal, and wherein the means for reducing the voltage at the source of the first transistor comprises a second transistor having a source connected to the source of the first transistor, and a resistor connected between a drain of the second transistor and the first voltage supply terminal.

15. The circuit of claim 14, wherein the means for reducing the voltage at the source of the first transistor comprises further comprises an amplifier having a first input terminal coupled to the drain of the second transistor and a second input terminal coupled to receive a reference voltage.

16. The circuit of claim 15, wherein the means for reducing the voltage at the source of the first transistor further comprises:
a second resistor having a first terminal coupled to the first voltage supply terminal; and
a constant current source coupled between a second terminal of the second resistor and a ground supply terminal, wherein the reference voltage is provided at the second terminal of the second resistor.

17. The circuit of claim 16, wherein the means for reducing the voltage at the source of the first transistor further comprises a third transistor coupled between a gate of the first transistor and the ground supply terminal, the third transistor having a gate coupled to an output of the amplifier.

18. The circuit of claim 13, wherein the means for maintaining the predefined voltage at the source of the first transistor comprises:
a linear amplifier having a first input terminal coupled to receive a reference voltage, and an output coupled to a gate of the first transistor; and
a resistive divider circuit that generates a feedback voltage in response to the voltage at the source of the first transistor, wherein the feedback voltage is provided to a second input terminal of the linear amplifier.

19. A current limiting circuit for limiting a current through an output stage transistor having a drain connected to a first voltage supply terminal, comprising:
a first transistor having a source connected to a source of output stage transistor, and a gate connected to a gate of the output stage transistor;
a first resistor coupled between a drain of the first transistor and the first voltage supply terminal;
a second resistor coupled between the first voltage supply terminal and a node;
a constant current source coupled between the node and a second voltage supply terminal;
an amplifier having a first input terminal coupled to the drain of the first transistor and a second input terminal coupled to the node; and
a third transistor coupled between the gate of the output stage transistor and the second voltage supply terminal, wherein a gate of the third transistor is coupled to an output terminal of the amplifier.

20. The current limiting circuit of claim 19, wherein the first voltage supply terminal provides a positive voltage, and the second voltage supply terminal is coupled to ground.

21. The current limiting circuit of claim 19, wherein the output stage transistor and the first transistor are NMOS transistors.

22. The current limiting circuit of claim 19 wherein the output stage transistor and the first transistor are NLDMOS transistors.

23. A circuit comprising:
a first amplifier having an output terminal;
a first bipolar transistor that provides an output current to a load in response to a voltage on the output terminal, wherein a predefined voltage is provided to the load as long as the output current is less than a predefined maximum current;
a second bipolar transistor having an emitter connected to an emitter of the first bipolar transistor and a base connected to a base of the first bipolar transistor, the second bipolar transistor drawing a sensing current proportional to the output current; and
a resistor connected in series with a collector of the second bipolar transistor.

24. A method of limiting an output current generated in response to an output voltage of a linear amplifier, the method comprising:
commonly biasing bases of a first bipolar transistor and a second bipolar transistor with the output voltage of a linear amplifier, wherein the first and second bipolar transistors operate in linear modes;
supplying an output current to a load through commonly coupled emitters of the first and second bipolar transistors;
deriving a first voltage from a current through the second bipolar transistor;
comparing the first voltage with a reference voltage to obtain a comparison result; and
controlling the output voltage of the linear amplifier in response to the comparison result.
